(19) United States
(12) Patent Application Publication
(10) Pub. No.: US 2025/0197036 A1
(43) Pub. Date: Jun. 19, 2025

(54) DEVICE FOR SUPPORTING A FLUID-CIRCULATION DUCT, AND ASSEMBLY COMPRISING SUCH A DEVICE AND SUCH A DUCT

(71) Applicant: ARIANEGROUP SAS, Les Mureaux (FR)

(72) Inventors: Alain PYRE, Vernon Cedex (FR); Jean-Noël CHOPINET, Vernon Cedex (FR); Nicolas LUQUET, Vernon Cedex (FR); Alexandre FRENE, Vernon Cedex (FR)

(73) Assignee: ARIANEGROUP SAS, Les Mureaux (FR)

(21) Appl. No.: 18/842,960

(22) PCT Filed: Mar. 3, 2023
(86) PCT No.: PCT/FR2023/050292

§ 371 Date: Aug. 30, 2024

(30) Foreign Application Priority Data
Mar. 3, 2022 (FR) 2201872

(51) Int. Cl. B64G 5/00; F16L 3/01

(52) U.S. Cl. CPC B64G 5/00; F16L 3/01

(57) ABSTRACT

A three-point propulsion system of an orbital deployment space module for at least one satellite including: chassis including exactly three first housings shaped to each receive a propulsion unit and at least one second housing shaped to receive a tank, at least one liquid fuel tank disposed in a second housing, and exactly three propulsion units, each propulsion unit being disposed in one of the first housings, and each propulsion unit including at least one thruster.

### TECHNICAL FIELD

The present disclosure relates to a device for supporting a fluid-circulation duct.

### PRIOR ART

In aeronautics, and in the space sector, various fluids are employed (oxygen, hydrogen, helium . . . ) which must be sent from one point to another, for example between an engine and a launcher, or between a launcher and its firing point, by ducts for circulating the fluid or fluids in question.

Such fluid-circulation ducts satisfy a particularly demanding specification due to the severe operating conditions to which they are subjected. In particular, this type of duct must be able to satisfy the following requirements (cumulative or not):
the duct can be relatively long (on the order of 0.3 to 2 meters, for example);
it can convey fluid that is pressurized or not depending on the operating phases;
it can convey liquid or gas;
it can have a large diameter and a high mass flow rate (on the order of 250 kg/s, or even more, for example);
it can be subjected to severe dynamic stresses;
it may need to accept small displacements of thermomechanical origin, particularly at its two opposite ends which are attached to/suspended from different components, themselves connected in a more or less statically indeterminate manner, all these components and the elements that connect them having different temperatures as well as different thermal dilation coefficients;
it may need to accept engine movements/displacements;
it may need to connect different engine parts to one another or a part of an engine to a part of a launcher.

Generally, taking these conditions into account, the standard (conventional) commercial products such as hoses made up of (undulating) metal convolutions covered with metal braid at their opposite ends are not suitable for the intended applications. In fact, when the hose must connect together different engine parts or a part of one engine to a part of a launcher, its length (for example on the order of 1 m for a diameter of 15 cm) is such that its first natural (vibration) frequency proves to be too low to prevent large dynamic displacements that are unacceptable in operation.

The use of (conventional) standard commercial hoses is possible, however, when their length is sufficiently low or when they are sufficiently rigid to not give rise to dynamic displacements that are too high and are unacceptable in operation.

When it is not possible to use such conventional hoses, it is possible to resort to lines with gimbals (with metal convolutions to contain pressure and provide sealing) or to composite assemblies of several short hoses connected by rigid line sections.

These solutions are not satisfactory, however, and there clearly exists a need in that respect, particularly to allow using existing long (conventional) hoses to convey a fluid by reducing the disadvantages described above during dynamic displacements or offsets of the hoses under operating conditions.

### DISCLOSURE OF THE INVENTION

One embodiment relates to a device for supporting at least one fluid-circulation duct, characterized in that the supporting device comprises:
a link, called a supporting link, intended to provide support to said at least one duct by means of two end parts of the link which are separated from one another in a longitudinal direction X, each end part being able to adopt, in a transverse section view relative to the longitudinal direction X, a generally curved shape intended to receive and to support a portion of said at least one fluid-circulation duct, the two end parts of the link being connected together by two intermediate parts of the link, each intermediate part connecting one of the two opposite ends of an end part to one of the two opposite ends of the other end part,
two links called fastening links intended to provide the fastening of the supporting device by means of two opposite ends of each fastening link, each of which is intended to be fastened to an outer structure of the supporting device,
at least two elements, called connecting elements, which are separated from one another in the longitudinal direction X and which provide the connection between the supporting link and the fastening links, each connecting element having, on the one hand, at least one fastening link and at least one intermediate part of the supporting link passing through it and, on the other hand, being able to allow sliding of these links through the connecting element.

The supporting device allows supporting said at least one fluid-circulation duct in two separate zones along its length by means of two separate end parts of the supporting link, which allows increasing the first natural frequency (this frequency is equal to ½π(k/m)^{1/2} where k is the stiffness and m the mass of the duct) of the supporting device of said at least one fluid-circulation duct and therefore limiting the amplitude of the dynamic response of the at least one duct when the latter is subjected to strong dynamic excitations at its ends. Generally, the dynamic response of said at least one duct is reduced to an acceptable level, which allows avoiding the deterioration, perhaps the fracture of the latter. More particularly, the supporting device above allows reducing the amplitude of transverse/lateral displacement of said at least one duct relative to the aforementioned longitudinal direction, this at an acceptable level, while allowing following the movement of the latter, particularly during relative movements between the structures to which the fastening links are attached (example: engine and its launcher—in particular in the event of deflection of the engine, or parts of the engine and of the launcher). It will be noted that said at least one duct can be flexible or rigid. The supporting device can have a different shape when it is not functionally linked to said at least one duct and, in particular, its two separate end parts do not necessarily adopt a generally curved (concave) shape in the absence of a duct. The supporting device can be used to support one or more ducts that are separate or physically joined by a shroud or an fastening system.

According to other possible features:
the supporting device comprises two pairs of connecting elements each formed from two connecting elements separated in the longitudinal direction, the two pairs of connecting elements being separated transversely and parallel to one another and to the longitudinal direction, each of the two connecting elements of each pair of connecting elements having, on the one hand, one of the two fastening links and, on the other hand, one of the two parallel intermediate parts of the supporting link passing through it;
each connecting element is a band or a ring; the shape of each connecting element can be circular or elliptical or, more generally, a shape suited to ensure the sliding of the fastening links in the longitudinal direction and of the supporting link in the transverse and longitudinal directions;
the supporting device includes a spacing element arranged between said at least two connecting elements in the longitudinal direction;
the spacing element is selected from the following elements: a rigid rod longitudinally connecting said at least two connecting elements to one another, and a rigid tube which has, on the one hand, one of the two fastening links and, on the other hand, one of the two parallel parts of the supporting link passing through it, the tube having an inner diameter smaller than the diameter of the connecting elements;
a traction preload (or “pre-drawn tight”) is applied (prior to use) to both fastening links (during the assembly/installation of the duct(s)—device assembly, the fastening links are subjected to lengthwise tension/traction before each of them is attached to an outer structure);
the supporting link and the fastening links are made of materials such as Kevlar (registered trademark), stainless steel, Inconel (registered trademark).

Another embodiment relates to an assembly which comprises at least one fluid-circulation duct and at least one device for supporting said at least one fluid-circulation duct, as briefly disclosed above. By way of an example, several supporting devices can be used to support different portions of one or more ducts.

According to other possible features:
the assembly includes a means for protecting said at least one fluid-circulation duct against deformation, which is positioned between, on the one hand, each of the two separate end parts with a generally curved shape of the supporting link, in a transverse section view and, on the other hand, each portion of said at least one fluid-circulation duct which is received and supported by the end part in question;
the protection means is selected from the following elements:
a protection strip arranged between each of the two separate end parts with a generally curved shape of the supporting link and each portion in question of said at least one fluid-circulation duct,
a positioning guide having a U-shaped transverse section and which is arranged between each of the two separate end parts with a generally curved shape of the supporting link and each portion in question of said at least one fluid-circulation duct in order to receive the end part of the supporting link in question; each of the two sides or branches of the U allows preventing the duct(s) from being displaced laterally and extend from the part forming the bottom of the U and which locally protects the duct;
a sleeve with a circular cross section arranged around each of the two separate end parts with a generally curved shape of the supporting link.

Another embodiment relates to a space vehicle such as a launcher, comprising inner components and at least one duct-supporting device assembly as briefly disclosed above, said at least one fluid-circulation duct of said at least one assembly fluidly connecting together two inner components of said space vehicle.

Another embodiment relates to a fluid supply system for an aeronautical or space vehicle, comprising at least one duct-supporting device assembly as briefly disclosed above.

### BRIEF DESCRIPTION OF THE DRAWINGS

The object of the present disclosure and its advantages will be better understood upon reading the detailed description provided hereafter of different embodiments given by way of non-limiting examples. This description refers to the appended pages of figures, in which:

FIG. 1A shows a possible example of an application of a fluid duct supporting device connecting a launcher to its engine in side view;

FIG. 1B shows a front view of the device of FIG. 1;

FIG. 1C shows the device of FIG. 1A with an angulation of the engine;

FIG. 1D shows the device of FIG. 1B with an angulation of the engine;

FIG. 2A shows a possible embodiment of the supporting device of FIGS. 1A-D in front view;

FIG. 2B shows a side view of the supporting device of FIG. 2A;

FIG. 2C shows a transverse view of the supporting device of FIGS. 2A-B;

FIG. 2D is a partial enlarged view of one of the connecting elements of FIGS. 2A-C connecting links of the supporting device;

FIG. 3A shows a variant embodiment of the supporting device of FIGS. 2A-D in front view;

FIG. 3B shows a side view of the supporting device of FIG. 3A;

FIG. 3C shows another variant embodiment of the supporting device of FIGS. 2A-D in side view;

FIG. 3D shows yet another variant embodiment of the supporting device of FIGS. 2A-D in side view;

FIG. 4A shows another possible embodiment of the supporting device of FIGS. 1A-D in transverse view;

FIG. 4B shows a top view of the supporting device of FIG. 4A

FIG. 5 illustrates a possible configuration which inserts a damping cushion between bearing structures;

FIG. 6A illustrates a first possible configuration of a plurality of ducts supported by a supporting device like that of FIGS. 2A-D;

FIG. 6B illustrates a second possible configuration of a plurality of ducts supported by a supporting device like that of FIGS. 2A-D;

FIG. 6C illustrates a third possible configuration of a plurality of ducts supported by a supporting device like that of FIGS. 2A-D;

FIG. 6D illustrates a fourth possible configuration of a plurality of ducts supported by a supporting device like that of FIGS. 2A-D;

FIG. 7A shows another possible example of an application of a fluid duct supporting device within a propulsion system of a launcher;

FIG. 7B shows other possible examples of a fluid duct supporting device connecting a launcher to a ground installation and connecting two inner components of a launcher to one another;

FIG. 7C shows another possible example of a fluid duct supporting device connecting a ground installation to an aircraft.

### DESCRIPTION OF THE EMBODIMENTS

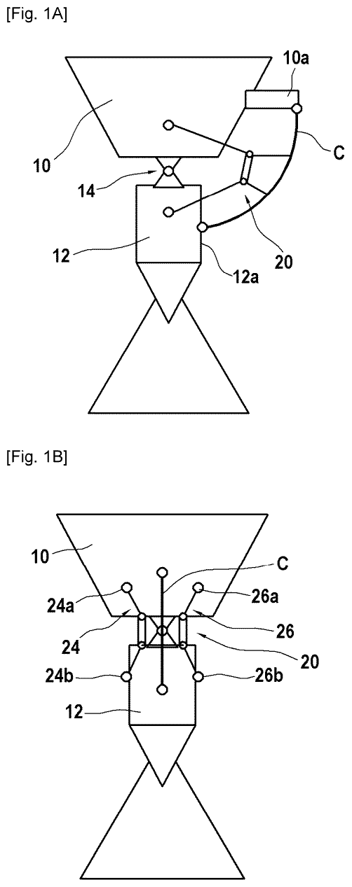

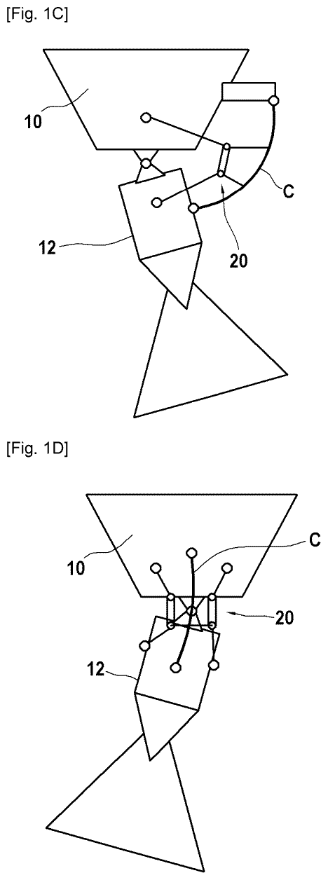

FIGS. 1A and 1B show schematically, respectively in side view and front view, an exemplary embodiment where a fluid duct supporting device 20 is used to sustain or support a fluid duct C which conveys a fluid, such as hydrogen, methane, oxygen, nitrogen, helium between a launcher 10 and an engine 12 attached to the latter by an articulated mechanism of the gimbal 14 type able to transmit a torsion movement. Here the fluid duct C is a conventional hose which has a relatively high length (example: one meter) allowing it to connect a part 10a of the launcher 10 to a part 12a of the engine 12. Schematic FIGS. 1C and 1D show the angular movements which the engine can adopt and therefore that the duct C must follow while remaining functional, without deteriorating, under the operating conditions of the launcher-engine assembly. The dotted lines in FIGS. 1C and 1D illustrate the rest position (no engine angulation) of the duct C.

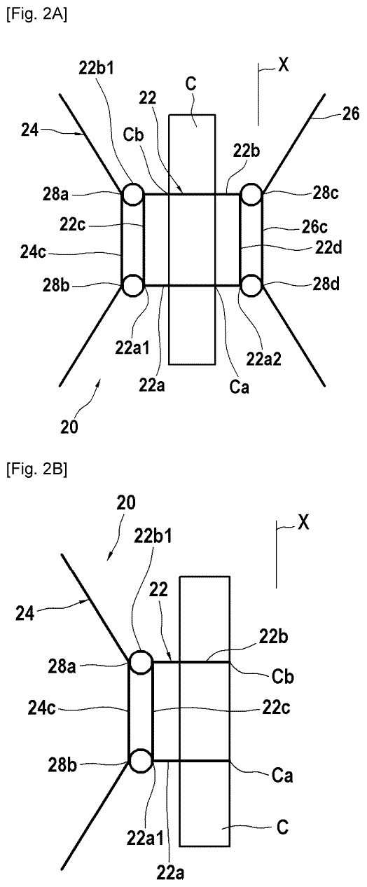

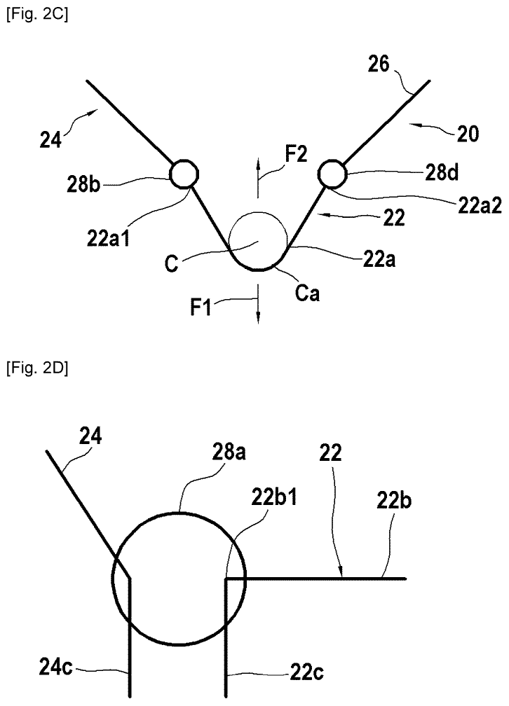

The supporting device 20, which will be described in more detail in FIG. 2A and later, can allow following these engine angulation movements, just as it can also limit lateral displacements in the dynamic response of the duct C, particularly in the case of large dynamic stresses (it will be noted that the device can also limit vertical displacements in the case where the duct is arranged horizontally). The device 20 follows relatively flexibly the movement of the flexible duct C relative to the surrounding bearing structures 10 and 12.

FIGS. 2A-2C illustrate a possible embodiment of the supporting device 20 of the duct C, respectively in front (the duct C is in the background), side and transverse views. Although the duct C extends here in a manner that is curved at rest (when it is installed and attached to the parts 10a and 12; it will be noted that in other configurations the duct can extend rectilinearly at rest), as illustrated in FIGS. 1A-B, it is possible to consider that locally the duct extends substantially in a longitudinal direction denoted X in FIGS. 2A-2C (straight duct),

The supporting device 20 comprises mainly:
a link 22 sustaining or supporting the fluid-circulation duct C,
two fastening links 24, 26 which allow attaching or fastening the device 20 to surrounding structures (here the launcher 10 and the engine 12),
at least two bands 28a-d or connecting elements (alternatively these elements can have other shapes: rings . . . ) which are separated from one another in the longitudinal direction X and which connect the supporting link 22 and the fastening links 24, 26 together. The supporting link 22 passes through all the bands regardless of their number, while, when there are only two bands, the fastening links pass through the totality of the bands. When there are four bands, each fastening link passes through only two of the four bands, as will be seen below. The supporting device 20 and the duct C jointly form a functional assembly when the device is attached to the surrounding bearing structures and is linked to the duct by the connecting structure described briefly above and in more detail hereafter. The connecting elements are closed to prevent the links or cable that pass through them from escaping from them. The links 24 and 26 are simply slipped into the connecting elements 28a-d.

In the embodiment described, the supporting device 20 comprises two pairs of bands each formed from two bands 28a, 28b and 28c, 28d which are separated from one another (within each pair) in the longitudinal direction X. The two pairs of bands 28a, 28b and 28c, 28d are separated transversely from one another (in the plane of FIG. 2C), arranged along the duct C and parallel to one another (or parallel to one another overall, i.e. they can accept angles on the order of a few degrees between their overall alignment directions) and to the longitudinal direction X. The connecting structure with four bands allows forming a structure supporting the duct with the general shape of a cradle with two supporting zones, as shown in the transverse view of FIG. 2C with the supporting zone 22a.

The supporting link 22 is generally rigid overall, but may however have a certain elasticity without however extending excessively when a preload or prestress is applied to the links 24 and 26. This is for example a link made of Kevlar (registered trademark), of stainless steel, of Inconel (registered trademark). The supporting link 22 (example: a cable) is closed on itself and inserted through the four bands 28a-d so as to form:
two separate end parts 22a, 22b separated from one another in the longitudinal direction X and arranged face to face (FIGS. 2A-B), each of these parts being able to adopt, in a transverse section view (FIG. 2C) a generally curved shape (generally a U shape more or less open at its upper part) the concavity of which allows receiving and supporting (in directions perpendicular to the longitudinal direction of the duct, particularly in the displacement direction F1 in FIG. 2C) a portion Ca, Cb of the fluid-circulation duct C; it will be noted that no support is applied to the duct C in the displacement direction F2 opposite to F1;
two intermediate parts 22c, 22d parallel to one another overall, to the duct C and to the longitudinal direction X (FIGS. 2A-B) (a gap of several degrees can be contemplated between the two intermediate parts, the duct and/or the longitudinal direction) and each of which connects one of the two opposite ends 22a1, 22a2 of the generally curved shape of one 22a of the two end parts 22a, 22b to one of the two opposite ends 22b1, 22b2 of the generally curved shape of the other separate end part 22b, respectively at bands 28a, 28b, for the end part 22c, and at bands 28c, 28d for the end part 22d (see for example the partial enlarged view of the band 28a in FIG. 2D).

It will be noted that a system allowing bonding the two ends/tips of the supporting link 22 (by crimping or welding) can be contemplated. Alternatively, hooks can equip the two ends/tips of the supporting link 22 and be hooked together once the link 22 is slipped into the bands. Alternatively, a knot can be made in the link 22.

Supporting the duct at two distinct zones, namely supporting two conduit portions Ca, Cb respectively by the two separate end parts 22a, 22b, allows distributing the support force and thus avoids a local concentration of stresses on the duct. Generally, the two end parts 22a, 22b are separated axially from one another by a minimum distance which is comprised between two and five times the diameter of the duct C. The two end parts 22a, 22b are arranged separately from the two opposite ends of the duct(s) that the device supports and the maximum separation between these two parts depends on the stiffness of the duct(s) to be supported. The greater the stiffness, the more the two end parts can be made closer to one another. These general remarks apply regardless of the embodiment of the invention or its variants.

Each end part, such as the part 22a in FIG. 2C, extends from one of the bands, 28b here, to the other band of the other pair which faces it transversely, 28d here, by forming toward the bottom a curvature or concavity (U-shaped here) at the bottom of which is housed a portion (Ca here) of the duct. The two bands, 28b, 28d here (FIG. 2C), are thus arranged vertically at a position (or dimension) greater than the position (or dimension) of the bottom of the end part, labeled here 22a (FIG. 2C), and of the duct C. The two bands 28b, 28d are separated transversely so as not to be directly arranged (vertically) above the duct C (FIG. 2C) and are arranged at the two opposite ends of the end part 22a so as to adopt with the latter a U shape overall, the two branches of which extend along an angular sector of a maximum of approximately 60°. The transverse spacing between the two bands 28b and 28d is equal to k* the diameter of the duct C (with k comprised between 2 and 4 in the case where the angle is) 60°. The same description applies to the other separate end part 22b with the bands 28a and 28c. Moreover, the minimum spacing between the median plane passing through the two bands 28b, 28d and the median plane passing through the duct C can be comprised between two and four times the diameter of the duct in this exemplary embodiment.

Each of the two fastening links 24, 26 includes two opposite ends 24a-b, 26a-b illustrated for example in FIG. 1B and each of which is intended to be attached (for example by means of bands) to a structure such as the launcher 10 and the engine 12. Each fastening link 24, 26 extends from one end to the opposite end while passing through two successive bands 28a, 28b of the device 20 through an intermediate part 24c of the link 24 and the two successive rings 28c, 28d through an intermediate part 26c of the link 26. The intermediate part 24c, 26c of each link 24, 26 which passes through the two bands of the same pair, extends parallel to the intermediate part 22c, 22d (supporting link 22) which passes through the same two bands. The links are cables with a slight elasticity: too great an elasticity does not contribute sufficient stiffness to the “flexible links+fastening links” assembly, and too little elasticity reduces the “fluidity” of support of the device according to the embodiment of the invention, in the event of engine deflection. By way of examples of the materials of the fastening means, steel, Inconel and Kevlar can be cited.

In the embodiment described, the fastening links 24, 26 can be subjected to a pre-tension (applied and adjusted in known manner on the links or cables, for example as a function of prior tests) during their placement on the bearing structures and in connection with the duct C. Thus, they apply a pre-tension to the duct C upon assembly. When the duct is pressurized it tends to deform outward naturally (and not toward the bearing structures), i.e. in the direction indicated by the arrow F1 in FIG. 2C, which increases the tension in the links 24 and 26. The fastening links are for example made of materials such as Kevlar (registered trademark), stainless steel, Inconel (registered trademark).

It will be noted that the fastening links 24, 26 and the supporting link 22 which pass through the bands are able to slide/slip inside them (in other words, a relative sliding movement can occur between the bands and the different links), which allows the supporting device 20 to adapt, to a certain extent, to the movements of the duct C and of the surrounding movable bearing structures 10 and 12, particularly in the case of engine angulation (in other words this allows following as “gently” as possible the movement/displacement of the duct C (in particular in the case of engine deflection)). The device 20 can in fact follow certain movements of the duct C and limit the amplitude of certain movements (example: lateral displacements in a direction perpendicular to the direction of displacement F1 and F2 in FIG. 2C) which might risk deteriorating the duct.

The supporting device 20 can allow attaining a minimum factor of two between the excitation frequency of the launcher 10 and engine 12 assembly and the first natural frequency of the duct C (once it is supported by the device that is the object of the invention), which allows avoiding vibratory phenomena that are too intense (unacceptable amplitude of the lateral dynamic displacements of the duct which would be able to damage the duct). In other words, the device allows modifying (increasing) the first frequency of the range of frequencies in which the levels of dynamic excitation originating in the launcher are maximum. There follows a reduction in the dynamic amplification factor of the response of the duct C.

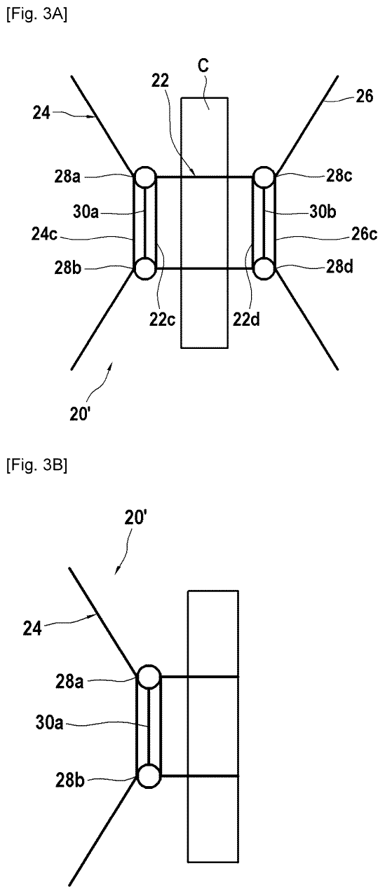

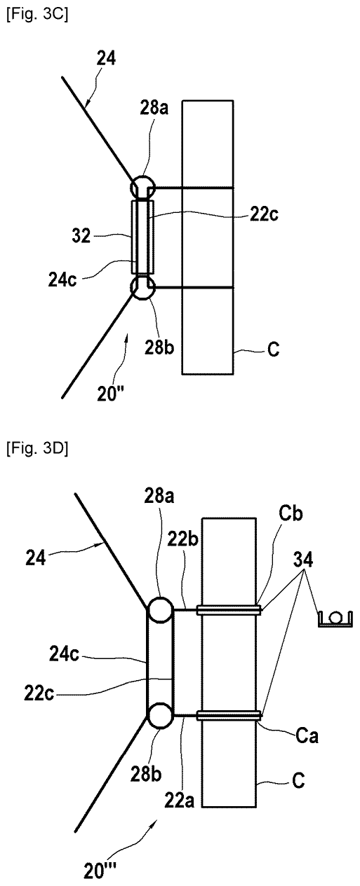

FIGS. 3A and 3B are respectively front and side views illustrating a variant embodiment of the supporting device of FIGS. 2A-D, in which is provided a spacing element (an element which provides a minimum spacing) between the two separate bands of the same pair of bands 28a-b and 28c-d in the longitudinal direction X (or in a longitudinal direction overall which is therefore able to accept relative transverse angular gaps), this for both pairs of bands. The supporting device 20′ includes more particularly two spacing elements 30a and 30b that are parallel to one another and to the duct C, which thus maintain a minimum spacing between the two bands 28a, 28b and 28c, 28d respectively, preventing the two bands of the same pair from approaching one another axially. Due to the retention of a minimum spacing between the bands, the forces for supporting the duct are better distributed and therefore more effective than if the bands were able to approach one another longitudinally.

By way of an example (FIGS. 3A-B), each spacing element can be a rigid rod 30a, 30b which connects the two bands of the same pair to one another at its two opposite ends while being, for example, attached (example: by welding) to these bands, or perhaps not being attached to the bands. Each rod is for example arranged between the two parallel intermediate parts 22c, 24c and 22d, 26c of the links passing through the bands in question.

Alternatively (FIG. 3C), each spacing element of the supporting device 20″ can be a rigid tube, such as the tube 32 in the side view of FIG. 3C, which has, on the one hand, an intermediate part of each of the two fastening links, here the part 24c of the link 24 and, on the other hand, each of the two parallel intermediate parts of the supporting link 22, here the part 22c, passing through it. The tube 32 has an inner diameter which is less than the diameter of the bands 28a-b so that they cannot penetrate into it. An identical tube, not shown, is provided to surround the parts 26c and 22d, between the bands 28c-d.

In a variant embodiment of each of the support devices of FIGS. 2A-D and 3A-C, the supporting device 20″ can include a means for protecting the fluid-circulation duct C against deformation. A means of this type has as its function to distribute the contact pressure between, on the one hand, each end part 22a, 22b with the general shape of a U which partially surrounds a duct portion Ca, Cb (FIG. 2C) and, on the other hand, each corresponding duct portion Ca, Cb in contact with an end part in order in particular to avoid the pinching or punching of the duct C (a hose here) by the supporting link 22 under the operating conditions of the duct C. The means of protection is more particularly positioned between each end part 22a, 22b of the supporting link and each portion Ca, Cb of the duct received in the concavity of the general U shape of the end part in question, and sustained by the latter.

As shown in FIG. 3D, the means of protection comprises two positioning guides 34, each of which has a U-shaped transverse section and each of which is arranged between each of the two separate end parts 22a, 22b of the supporting link 22 and each portion in question Ca, Cb of the fluid-circulation duct C in order to receive, inside the guide, the end part 22a, 22b in question. The lateral edges of each guide prevent the portion in question of the duct from moving laterally out of the protection zone.

By way of variants (not shown), the means of protection can take the shape:
of a protecting (or reinforcing) strip arranged between each of the two separate end parts 22a, 22b of the supporting link 22 and each portion in question Ca, Cb of the duct C; it will be noted that the strip can suffice instead of the U-shaped positioning guide in the case where a spacing element is arranged between the two bands of each pair (FIGS. 3A-C) and the width of the strip must be sufficient so that the link remains on it under the operating conditions of the duct, particularly in the case of longitudinal or axial displacements of the duct;
of a sleeve of circular cross section around each of the two separate end parts 22a, 22b of the supporting link, each sleeve thus being in contact with each portion in question Ca, Cb of the duct C.

It will be noted that each of the elements described above can be integrated into the supporting link 22 or into the duct C, perhaps be independent of each of them or simply be interposed between them at the time of their functional linking.

By way of a variant, not shown, additional links or cable can be associated with the fastening links 24 and 26, along them, in order to limit their lateral displacements during the flight phases where the duct C is not pressurized and therefore not stiffened or rigidified. These additional links or cables can be attached to the engine or to the launcher, perhaps to both. It is also possible to connect the two parts of the link 24 together, just like the two parts of the link 26, i.e. the parts located above and below the “cradle” formed by the supporting link 22. It is also possible to directly connect the links 24 and 26 together.

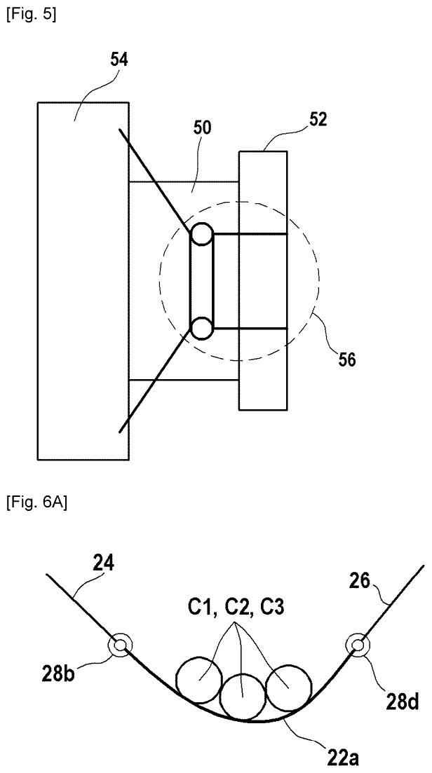

According to yet another variant, one or more intermediate damping cushion(s) can be arranged between the duct C and one or more rigid component(s) of the engine. FIG. 5 illustrates an example of a possible configuration where a cushion 50 of this type is positioned between two structures or components 52 and 54, between which is placed a supporting device 56 similar to any one of the devices described above.

Each of the supporting devices described above is particularly simple to place for sustaining/supporting a fluid duct and also simple to remove (example: in the event of maintenance).

It will be noted that several supporting device conforming to the preceding can be used on the same fluid duct (channel) conveying fluid between two points. Alternatively, it is also possible to put several devices conforming to the invention on the same duct C at different places along the duct, for example simply to sufficiently “calm” the dynamic offsets of the duct in all directions, if it is long.

Under operating conditions each of the supporting devices described above can behave as described hereafter.

In cooling phases and under thermomechanical stresses, the length of the duct C can decrease, which has the effect of slightly releasing the tension in the fastening links 24 and 26, while the duct C remains supported by these links.

During pressure loading:
the length of the duct C increases, which has the effect of increasing the tension in the fastening links 24 and 26;
the duct C is slightly displaced;
the bands 28a, 28b slide slightly along the link 24 and the bands 28c, 28d slide slightly along the link 26;
the generally U shape of each end part 22a, 22b becomes slightly more pronounced (the opening of the U closes);
the distance between the bands 28a to 28d varies;
the dynamic response of the duct C is limited due to the stiffening contributed by the device conforming to the invention.

During an engine angulation:
the duct C is displaced;
the bands 28a, 28b slide in a significant manner along the link 24 and the bands 28c, 28d slide along the link 26 (the amplitude of the sliding motion depends on the side toward which the engine turns; here it is considered that the engine turns toward the side which causes the greatest sliding at the bands 28a-b);
the general U shape of each end part 22a, 22b changes;
the distance between the bands 28a to 28d varies;
the dynamic response of the duct C is limited due to the stiffening contributed by the device conforming to the invention.

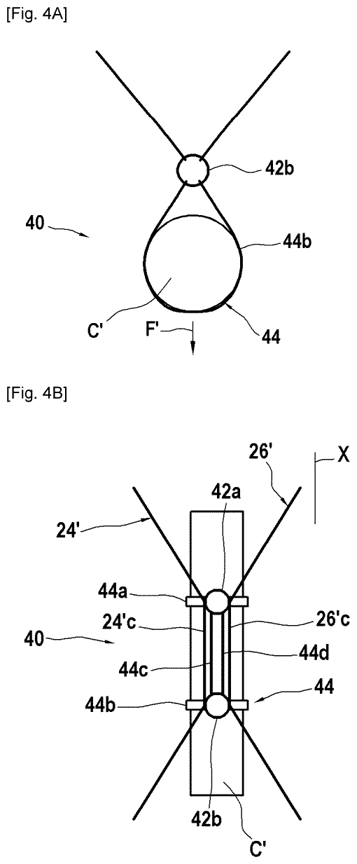

According to another embodiment illustrated in FIGS. 4A and 4B, the supporting device 40 comprises only two separate bands 42a, 42b (connecting elements), spaced from one another in the longitudinal direction X and which are arranged at the fluid circulation duct C′. Unlike other supporting devices, here the supporting link 44 includes two opposite end parts 44a, 44b each of which takes a generally curved shape surrounding more completely than in the preceding figures (U shape with an angle of approximately 60°) the duct C′ so as to form a loop or a collar around it (FIG. 4A) and the two opposite ends of which join one of the two bands (here 42b for the end part 44b). As for the preceding figures, the supporting link 44 also comprises two parallel or parallel overall intermediate parts 44c, 44d each of which extends from one band to the other and pass through it to join one of the two opposite ends of the end part 44a, 44b in question. As for the preceding figures, the supporting device 40 comprises two fastening links 24′ and 26′ which here extend through the same two bands through each of their intermediate parts 24′c and 26′c. Thus, each of the two bands 42a and 42b have the two intermediate parts 24′c and 26′c of the two fastening links and the two parallel intermediate parts 44c, 44d of the supporting link 44 passing through them.

This configuration has the same stiffening effectiveness as the configuration with four bands during a displacement of the duct in the direction indicated by the arrow F′ in FIG. 4A (see arrow F1 in FIG. 2C). During a lateral displacement of the duct C′ (horizontal displacement), this configuration allows limiting lateral dynamic displacements, but proves less effective, however, than the configuration with four bands.

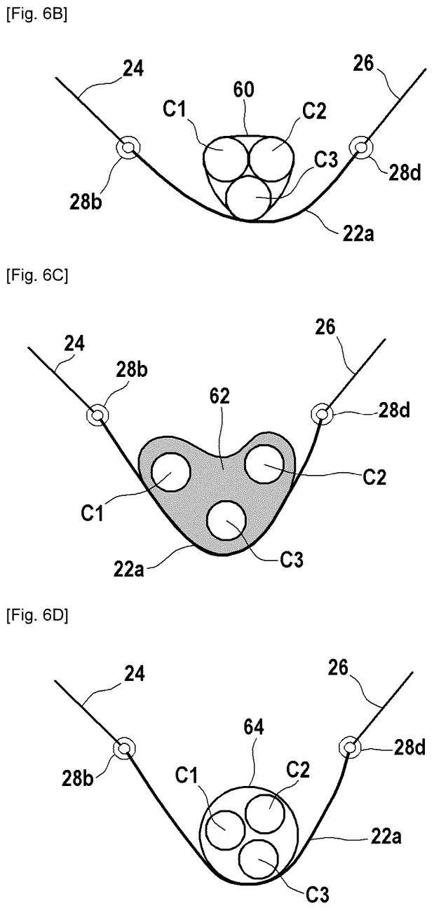

FIGS. 6A to 6D illustrate different possible configurations of assemblies or of systems in which a supporting device provides support to several fluid ducts (shown here for example by three ducts C1, C2, C3, although that number can differ).

In FIG. 6A three ducts C1-C3 arranged freely in the cradle formed by the two end parts, including the part 22a, are physically separated or free relative to one another, i.e. they can be freely displaced with respect to one another. In FIG. 6B the ducts C1-C3 are physically joined/grouped together by a link or a connecting element 60 (example: a Serflex (registered trademark) type link). In FIG. 6C the ducts C1-C3 are connected together by a comb type device 62 which provides a defined lateral separation between the ducts. In FIG. 6D the ducts C1-C3 are joined inside an outer shroud, here a tube which can extend over the virtual totality of the length of the ducts or only in the portion of their length which is supported by the support device.

All that has been written above, particularly the different features, functions and advantages of the preceding embodiment and its variants, also applies to the embodiment of FIGS. 4A-B, unless there is a technical incompatibility between the embodiments such as for example the number of bands.

The devices for supporting a fluid-circulation duct described above apply to any duct subjected to strong dynamic stresses and to thermomechanical stresses which are of a type to induce bending moments, tension or compression forces, shear forces, even torsional moments in the duct. This type of stress can result from pressures of the fluid passing through the duct causing depth effects from several kilos to several tonnes, from variations in temperature extending from the temperature of a cryogenic fluid (20° K) to the temperature of a hot gas (>800° K), from thermal excitation due to the engine, to the stage (launcher) or to wind on the umbilicals connecting the stage to ground installations of the firing point. More particularly, the values of thermomechanical stresses depend on the material, on the temperature and on the type of failure in question: for the behavior of the ducts under direct stresses (not repeated), it is preferable to avoid plasticizing of the ducts. For the risk of cracks being initiated due to fatigue or the risk of the propagation of cracks under dynamic loads (at low or high numbers of cycles), the allowable level of alternate stress at each cycle depends on the average stress, the material and on the temperature. The severity of the loads in the ducts supported by the device conforming to the invention translates into torsor forces (tension and shear forces; bending and torsion moments) the intensity of which depends on the materials of the ducts, on their means of support (including supporting devices conforming to the invention), on their limit conditions, on their length, on their type (type of hose, number of braids), on the materials supporting them, on their temperature and the displacements of their environment, i.e. on the components to which they are attached (example: engine deflection). They also depend on the amplitude of the dynamic response of the hoses in response to stresses originating, on the one hand, from the flow of the fluids that they convey and, on the other hand, on the excitation of the components to which they are connected. Generally, the hoses must not undergo unacceptable or irreversible damage under the influence of thermomechanical stresses; damage such as the initiation or propagation of cracks, and the plasticizing of the hoses.

The duct to be sustained/supported can be flexible or rigid as already mentioned above.

An elongate hose and an associated supporting device can replace a fluid (drainage) duct including one or more gimbals, which is therefore costly. In such a case, the elongate flexible element attached to the exhaust lines with several fastening elements of the Serflex (registered trademark) type (fastened to the bearing structure, particularly the engine, by inserting one or more cushion(s) as illustrated in FIG. 5). Inasmuch as, under operating conditions, the exhaust lines are hot, the clamping force exerted by the fastening elements of the Serflex type (registered trademark) increases.

In liquid propellant propulsion systems, small diameter rigid lines/ducts (for example line diameters of 6, 8, 12, 24 . . . 60, 90 and 110 mm can be involved) connect different parts of the engine and are sometimes not sufficiently supported, which can lead to dynamic frequencies that are too low and therefore to lateral dynamic displacements that are too high during test phases or in flight. The use of a supporting device such as one of those described above allows limiting the amplitude of the lateral displacements of such rigid lines to an acceptable level.

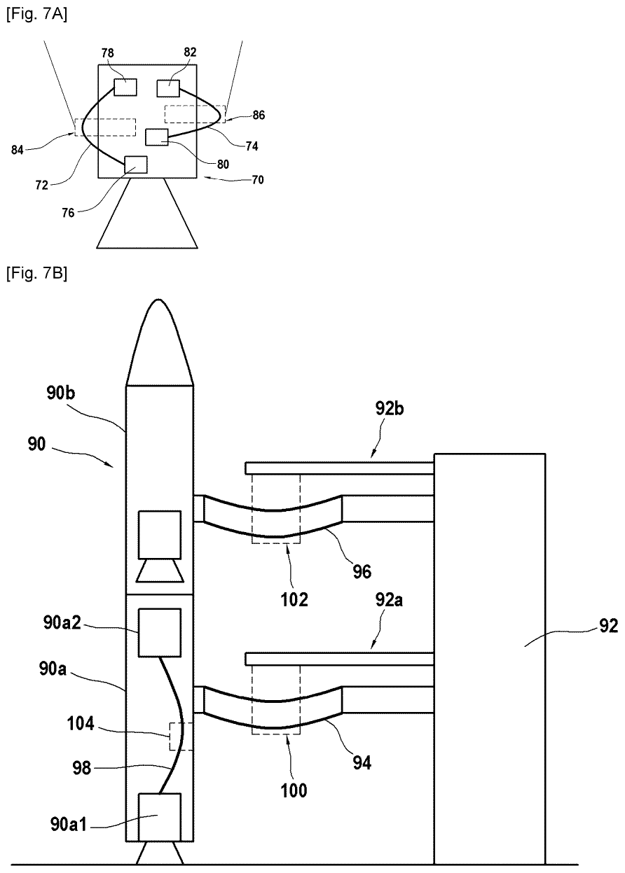

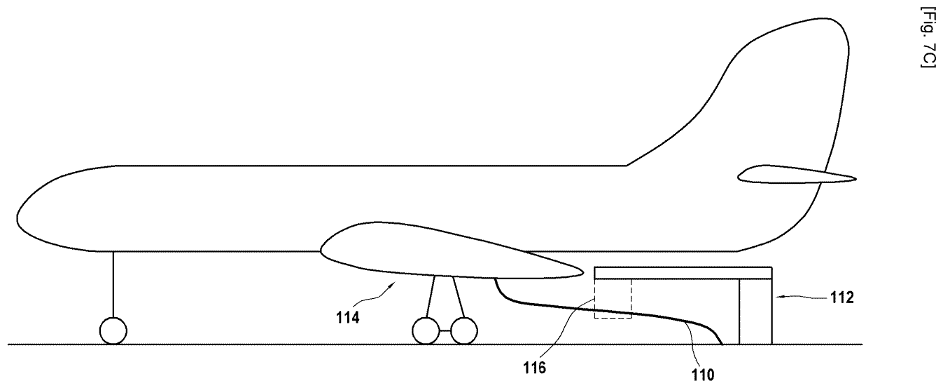

FIG. 7A illustrates an example of a possible application of a fluid duct supporting device according to the invention within an engine 70 of a space launcher, for example within a cryogenic propulsion system. The ducts 72, 74 in which one or various fluids circulate connect together two inner components of the engine. Here two ducts are shown, but a different number of ducts can of course be contemplated (example: one duct or more than two). The ducts can fluidly link/connect inner components or elements constituting the launcher to one another, and in particular of its propulsion system, namely without limitation elements of the fuel conditioning system, and/or elements of the fluid pressurization system and/or elements constituting the combustion chamber of the propulsion system, as for example an injection system. In the example shown, the fluid duct 72 connects a fluid pressurization system 78 to an injection system 76 and the fluid duct 74 connects two internal components 80 and 82 of a fuel conditioning system to one another. Each of these fluid ducts can be supported/sustained by one or more fluid duct supporting devices 84, 86 according to the invention as described above. The fluid duct(s) and the supporting device(s) jointly form one or more duct-device assemblies.

FIG. 7B illustrates a possible example of an application of a fluid duct supporting device according to the invention between a space launcher 90 and a ground installation 92 (firing point). More particularly, one or more fluid ducts 94 (filling umbilicals for fluid supply) fluidly link/connect a lower part 92a of the ground installation 92 to a first stage 90a of the launcher 90 and one or more fluid ducts 96 (filling umbilicals for fluid supply) fluidly link/connect an upper part 92b of the ground installation 92 to a second stage 90b of the launcher 90. Likewise, two inner components of the first stage 90a of the launcher, for example an engine 90a1 and a fuel or oxidizer reservoir 90a2, can be fluidly linked/connected together by one or more fluid ducts 98. Each of these fluid ducts 94, 96, 98 can be sustained/supported by one or more fluid duct supporting devices according to the invention 100, 102, 104, as described above. The fluid duct(s) and the supporting device(s) jointly form one or more duct-device assemblies. It will be noted that said at least one duct-supporting device 94, 100 assembly is part of a fluid supply system of the space vehicle 90 and that the same is true of said at least one duct/supporting device 96, 102 assembly. The device 100 is for example fastened to the lower part 92a of the ground installation 92, the device 102 is for example fastened to the upper part 92b of the ground installation 92 and the device 104 is for example fastened to the first stage 90a of the launcher.

FIG. 7C illustrates a possible example of an application of a fluid duct supporting device according to the invention, in the aeronautical sector. More particularly, one or more fluid duct(s) 110 fluidly link/connect a ground installation 112 to an aeronautical vehicle such as an aircraft 114, particularly a fuel reservoir of the latter for supplying the latter with fuel. The fluid duct(s) 110 can be sustained/supported by one or more fluid duct supporting devices according to the invention, 116, as described above. The fluid duct(s) and the supporting device(s) jointly form one or more duct-device assemblies. It will be noted that said at least one duct-supporting device 110, 116 assembly is part of a fluid supply system of the aeronautical vehicle 114. The device 116 is fastened for example to the ground installation 112.

Although the present invention has been described by referring to specific embodiments, it is obvious that modifications and changes can be carried out on these examples without departing from the general scope of the invention as defined by the claims. In particular, individual features of the different embodiments illustrated/mentioned can be combined into additional embodiments. Consequently, the description and the drawings should be considered in an illustrative, rather than a restrictive sense.

It is also clear that all the features described with reference to a method are transposable, alone or in combination, to a device, and conversely, all the features described with reference to a device are transposable, alone or in combination, to a method.

1. A device for supporting at least one fluid-circulation duct, wherein the supporting device comprises:
a link called a supporting link intended to provide support of said at least one duct by means of two end parts of the link which are separated from one another in a longitudinal direction, each end part being able to adopt, in a transverse section view relative to the longitudinal direction, a generally curved shape intended to receive and to support a portion of said at least one fluid-circulation duct, the two end parts of the link being connected together by two intermediate parts of the link, each intermediate part connecting one of the two opposite ends of an end part to one of the two opposite ends of the other end part,
two links, called fastening links, intended to provide the fastening of the supporting device by means of two opposite ends of each fastening link, each of which is intended to be attached to an outer structure of the supporting device,
at least two elements, called connecting elements which are separated from one another in the direction longitudinal direction and which provide the connection between the supporting link and the fastening links, each connecting element having, on the one hand, at least one fastening link and at least one intermediate part of the supporting link passing through it and, on the other hand, being able to allow the sliding of these links through the connecting element.

2. The supporting device according to claim 1, wherein the supporting device comprises two pairs of connecting elements each formed from two connecting elements that are separate in the longitudinal direction, the two pairs of connecting elements being transversely separate and parallel to one another and to the longitudinal direction, each of the two connecting elements of each pair of connecting elements having, on the one hand, one of the two fastening links and, on the other hand, one of the two parallel intermediate parts of the supporting link passing through it.

3. The supporting device according to claim 1, wherein each connecting element is a band or a ring.

4. The supporting device according to claim 1, wherein it includes a spacing element arranged between said at least two connecting elements in the longitudinal direction.

5. The supporting device according to claim 4, wherein the spacing element is selected from the following elements: a rigid rod connecting longitudinally said at least two connecting elements to one another, and a rigid tube which has, on the one hand, one of the two fastening links and, on the other hand, one of the two parallel parts of the supporting link passing through it, the tube having an inner diameter less than the diameter of the connecting elements.

6. The supporting device according to claim 1, wherein a traction preload is applied in each of the two fastening links.

7. The supporting device according to claim 1, wherein the supporting link and the fastening links are made of materials such as Kevlar, stainless steel, Inconel.

8. An assembly, wherein it comprises at least one fluid-circulation duct and at least one device for supporting said at least one fluid-circulation duct according to claim 1.

9. The assembly according to claim 8, wherein it includes a means for protecting said at least one fluid-circulation duct against deformation, which is positioned between, on the one hand, each of the two separate end parts of the supporting link and, on the other hand, each portion of said at least one fluid-circulation duct which is received and supported by the end part in question.

10. The assembly according to claim 9, wherein the means of protection is selected from the following elements:
a protection band arranged between each of the two separate end parts of the supporting link and each portion in question of said at least one fluid circulation duct,
a positioning guide having a U-shaped transverse section and which is arranged between each of the two separate end parts of the supporting link and each portion in question of said at least one fluid-circulation duct, the positioning guide receiving and supporting in position the end part of the supporting link in question,
a sleeve with a circular cross section arranged around each of the two end parts separate from the supporting link.

11. A space vehicle such as a launcher, comprising inner components and at least one assembly according to claim 8, said at least one fluid-circulation duct of said at least one assembly fluidly connecting two inner components of said space vehicle.

12. A fluid supply system for an aeronautical or space vehicle, comprising at least one assembly according to claim 8.
